(19) United States
(12) Patent Application Publication
(10) Pub. No.: US 2015/0226653 A1
(43) Pub. Date: Aug. 13, 2015

(54) METHOD FOR MEASURING THE TENACITY OF A MATERIAL

(71) Applicant: Commissariat à I'énergie atomique et aux energies alternatives, Paris (FR)

(72) Inventors: Cindy Rountree, Bures-sur-Yvette (FR); Daniel Bonamy, Orsay (FR)

(21) Appl. No.: 14/420,086

(22) PCT Filed: Aug. 6, 2013
(86) PCT No.: PCT/EP2013/066478

§ 371 Date: Feb. 6, 2015

(30) Foreign Application Priority Data
Aug. 8, 2012 (FR) 12 57701

(51) Int. Cl. G01N 3/08

(52) U.S. Cl. CPC G01N 3/08

(57) ABSTRACT

A method for measuring the tenacity K_{c} of a material, wherein a cuboid test piece of the material with a central hole is placed between two jaws of a compression testing device, each of said jaws pressing on a far end of the test piece. The two jaws apply a force to each of the ends until the test piece fails completely. Variations of the applied compression force applied at each end of the test piece are measured as a function of the time, during compression. The maximum value F₀ of said compression force is determined. Three distinct zones are marked on the surface of one of the failure surfaces. A distance is measured L₀ between the edge of the hole and a transition line separating the second zone from the third zone, and the parameter K_{c} is calculated as a function of the force F₀ and the distance L₀.

### TECHNICAL FIELD

The field of the invention is the characterisation of materials and more specifically it relates to a method of measuring the tenacity K_{c} of a material without forming a pre-crack on this material.

### STATE OF PRIOR ART

The fracture of a material is a physical phenomenon that occurs under the effect of corrosion and/or external stresses. It may be provoked deliberately, for example to cut parts for industrial use, or accidentally. In both cases, it is desirable to precisely know the strength of the material at failure. This strength is characterised by a coefficient K_{c} called the tenacity, and knowledge of this strength is very important in several technological domains.

Techniques known in prior art to measure the tenacity K_{c} of a material require the creation of a pre-crack before making a test that consists of applying a force on a test piece of material by means of a compression testing device or a tensile testing machine and increasing this force to cause propagation of the pre-crack until the test piece breaks.

In order to calculate the tenacity K_{c}, it is necessary to know the length L₀ of the pre-crack immediately when it begins to propagate and the force F₀ applied at this time. Both of these measurements are often incorrect because firstly it is difficult to precisely determine the exact instant at which the pre-crack begins to propagate, in other words the instant at which the speed increases from a value equal to exactly zero to a finite value, and secondly the fact of introducing a pre-crack before the test piece is stressed in the compression testing device or the tensile testing machine makes it impossible to have a perfectly thin pre-crack perpendicular to the imposed stresses.

One purpose of the invention is to overcome the disadvantages of the methods according to prior art described above by using a technique in which there is no need to make a pre-crack on the material.

### PRESENTATION OF THE INVENTION

The purpose of this invention is satisfied by means of a method for measuring the tenacity K_{c} of a material consisting of:
placing a test piece of said material in the form of a cuboid drilled at its centre by a central hole between two jaws of a compression testing device, each of said jaws pressing on a far end of the test piece,
bringing the two jaws towards each other to apply a force to each of said ends until the test piece fails completely,
measuring the variations as a function of the time of the compression force applied at each end of the test piece, during compression,
determining the maximum value F₀ said compression force,
marking three distinct zones on one of the failure surfaces, namely a first zone close to the hole with a first type of relief, a second zone with a second type of relief and a third zone with a third type of relief less pronounced than the second type,
measuring the distance L₀ between the edge of the hole and a transition line separating the second zone from the third zone,
calculating the parameter K_{c} as a function of the force F₀ and the distance L₀.

The method according to the invention also comprises a step to move the two jaws away from each other after failure.

Preferably, the parameter K_{c} is calculated using finite element software.

In one embodiment of the invention, the test piece has dimensions satisfying the following equation:

$$5 \leq \frac{L}{W} \leq 10 and 2.5 \leq \frac{W}{φ} \leq 5 ,$$

the value of the tenacity K_{c} being obtained from the following formula:

$${K}_{L 0} = \frac{( {F}_{0} / S ) \sqrt{\frac{π}{2} φ}}{( \begin{matrix}0.3156 + 0.7352 \frac{w}{φ} + \\ 0.0346 {( \frac{w}{φ} )}^{2}\end{matrix} ) + \frac{2 {L}_{0}}{φ} ( \begin{matrix}- 0.4093 + \\ 0.3794 \frac{w}{φ} - 0.0257 {( \frac{w}{φ} )}^{2}\end{matrix} )}$$

In one variant embodiment of the method according to the invention, the test piece is put into an ultra high vacuum chamber while the tenacity K_{c} is being determined.

In a second variant embodiment of the method according to the invention, the test piece is totally or partially immersed in a non-corrosive liquid while the tenacity K_{c} is being determined.

In a third variant embodiment of the method according to the invention, the central hole is hermetically filled with a non-corrosive liquid while the tenacity K_{c} is being determined.

### BRIEF DESCRIPTION OF THE DRAWINGS

Other characteristics and advantages of the invention will become clear after the following description given as a non-limitative example with reference to the appended figures in which:

FIG. 1 diagrammatically shows a test piece of a material to be characterised;

FIG. 2 is a curve showing variations of the compression force F(t) applied at each end of the test piece as a function of time;

FIG. 3 diagrammatically shows the failure surface with three distinct zones.

### DETAILED PRESENTATION OF PARTICULAR EMBODIMENTS

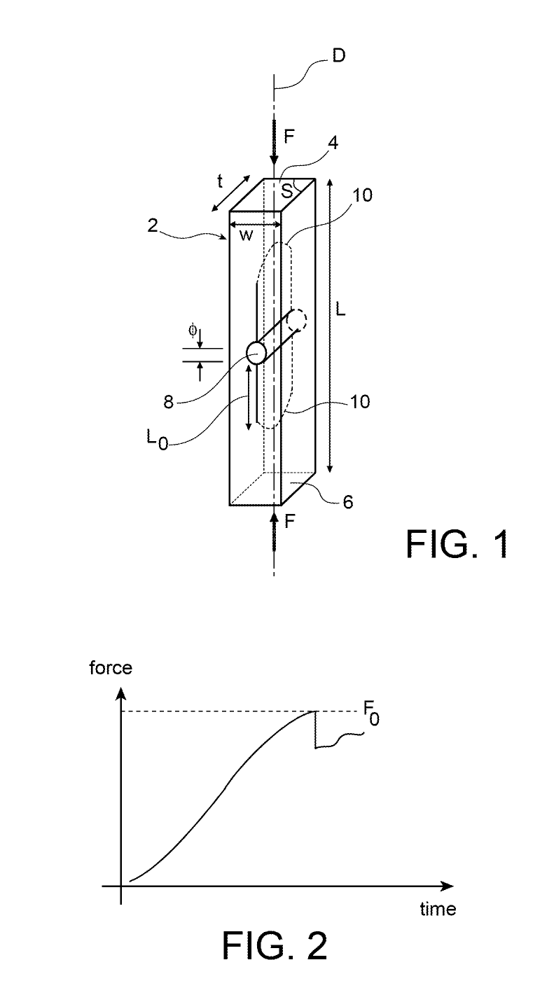

FIG. 1 shows a test piece of a material to be characterised in the form of a 25 mm long cuboid with a square cross-section of 5×5 mm², through which a 1 mm diameter central hole 8 is drilled perpendicular to two of its large parallel faces 4 and 6.

The invention makes use of the fact that for the geometry of a test piece according to FIG. 1, as long as the length of a crack remains less than Lₒ, the geometric stress amplification factor equal to the ratio of the stress intensity factor K to the applied force F reduces with the crack length, whereas it increases when the crack length exceeds the value Lₒ.

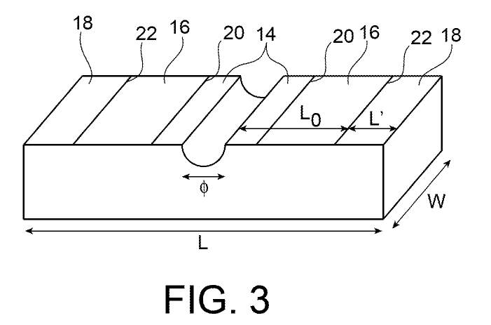

In order to measure the tenacity K_{c} of the test piece 2, the test piece is placed between the jaws of a compression testing machine and it is then centred such that the surfaces 4 and 6 are perpendicular to the axis D. The jaws are then brought towards each other for example at constant speed, so as to apply a force F along the direction of the hole 8 on each of the surfaces 4 and 6. Under the effect of the forces F, a crack 10 appears on the surface of the test piece 2 on each side of the central hole. The crack propagates until the test piece breaks into two pieces. It may be advantageous to then move the two jaws away from each other immediately. The value F(t) of the applied force during compression is measured as a function of time. As shown in FIG. 2, this force F(t) has a maximum that corresponds to the value Lₒ of the crack length. Furthermore, as shown in FIG. 3, the two failure surfaces of the test piece have three zones on each side of the hole, namely a first zone 14 close to the hole with a first type of relief, a second zone 16 with a second type of relief, and a third zone 18 with a third type of relief less pronounced than the second type. The zones 14, 16 and 18 are separated by so-called stop lines 20, 22, respectively. Depending on the material type, the stop lines 20, 22 are visible with the naked eye, or with an optical microscope, with an atomic force microscope, or a profile meter. The first zone 14 close to the hole corresponds to a fast propagation rate of the crack (K>Kᵣ). The second zone 16 corresponds to a stable propagation rate (K=Kᵣ). The third zone 18 corresponds to sudden acceleration of the crack propagation until crack failure occurs (K>Kᵣ). The line 22 separating the second zone 16 from the third zone 18 coincides with the value Lₒ. Its value is measured between this line and the edge of the hole 8. If the edge of the hole is fragmented, the measurement will be disturbed and it is then recommended that this length Lₒ should be calculated as

$${L}_{o} = \frac{L}{2} - \frac{φ}{2} - {L}^{′} .$$

The value K_{c} can then be calculated by finite elements starting from these values Fₒ and Lₒ (e.g. ABAQUS® or CAST3M® from CEA).

In the special case in which

$$5 \leq \frac{L}{W} \leq 10 and 2.55 \leq \frac{W}{φ} \leq 5 ,$$

a good approximation of the value K_{c} can be obtained as a function of Fₒ, Lₒ and the geometry of the test piece, using the following formula:

$${K}_{L 0} = \frac{( {F}_{0} / S ) \sqrt{\frac{π}{2} φ}}{( \begin{matrix}0.3156 + 0.7350 \frac{w}{φ} + \\ 0.0346 {( \frac{w}{φ} )}^{2}\end{matrix} ) + \frac{2 {L}_{0}}{φ} ( \begin{matrix}- 0.4093 + \\ 0.3794 \frac{w}{φ} - 0.0257 {( \frac{w}{φ} )}^{2}\end{matrix} )}$$

where S is the square cross-section of the test piece in m², φ is the diameter of the central hole in m, w is the test piece width in m, Lₒ is the crack length in m, and Fₒ is the compression force measured in N.

Advantageously, if the material corrodes in air, the measurement is made in an ultra high vacuum chamber.

It is also possible to immerse the test piece in a non-corrosive liquid or to simply fill the inside of the hole made in the test piece with this same liquid (for example tetradecane).

Measurements have been repeated on a test piece according to FIG. 1 made of Corning® silica 7980. The result obtained is Fₒ=8000±400N and Lₒ=8±0.1 mm so that K_{c} can be calculated equal to 0.77 MPam² (within 5%),

while Corning gives K_{c}=0.79 using a standard method.

With the method according to the invention, there is no need to make a pre-crack on the material test piece.

The method according to the invention can advantageously be applied to characterise a material used under extreme conditions, for example such as conditions under which the material is subject to strong irradiation.

The method according to the invention can also be used outside an ultra high vacuum chamber.

1. Method for measuring the tenacity K_{c} of a material, comprising the following steps:
placing a test piece (2) of said material in the form of a cuboid drilled at its centre by a central hole (8) between two jaws of a compression testing device, each of said jaws pressing on a far end (4,6) of the test piece;
bringing the two jaws towards each other to apply a force to each of said ends (4,6) until the test piece fails completely;
measuring the variations of the compression force applied at each end (4,6) of the test piece as a function of the time, during compression;
determining the maximum value F₀ said compression force;
marking three distinct zones on one of the failure surfaces, namely a first zone (14) close to the hole (8) with a first type of relief corresponding to a fast propagation rate of the crack, a second zone (16) with a second type of relief corresponding to a stable propagation rate of said crack, and a third zone (18) with a third type of relief less pronounced than the second type corresponding to sudden acceleration of the crack propagation until crack failure occurs, method characterised by the following steps:
measuring the distance L₀ between the edge of the hole (8) and a transition line (22) separating the second zone (16) from the third zone (18), said transition line (22) materialising the beginning of the sudden acceleration of the crack propagation until test piece failure occurs,
calculating the parameter K_{c} as a function of the force F₀ and the distance L₀.

2. Method according to claim 1 also comprising a step to move the two jaws away from each other after failure.

3. Method according to claim 1 in which the parameter K_{c} is calculated using finite element software.

4. Method according to claim 1 in which the test piece has dimensions satisfying the following equation
$$5 \leq \frac{L}{W} \leq 10 and 2.5 \leq \frac{W}{φ} \leq 5 ,$$
the value of the tenacity K_{c} being obtained from the following formula:
$${K}_{L 0} = \frac{( {F}_{0} / S ) \sqrt{\frac{π}{2} φ}}{( \begin{matrix}0.3156 + 0.7350 \frac{w}{φ} + \\ 0.0346 {( \frac{w}{φ} )}^{2}\end{matrix} ) + \frac{2 {L}_{0}}{φ} ( \begin{matrix}- 0.4093 + \\ 0.3794 \frac{w}{φ} - 0.0257 {( \frac{w}{φ} )}^{2}\end{matrix} )}$$
where S is the square cross-section of the test piece in m², φ is the diameter of the central hole in m, w is the test piece width in m, Lₒ is the crack length in m, and Fₒ is the compression force measured in N.

5. Method according to claim 1 in which the test piece (2) is put into an ultra high vacuum chamber while the tenacity K_{c} is being determined.

6. Method according to claim 1 in which the test piece is totally or partially immersed in a non-corrosive liquid while the tenacity K_{c} is being determined.

7. Method according to claim 1 in which the central hole is hermetically filled with a non-corrosive liquid while the tenacity K_{c} is being determined.
